(19) United States
(12) Patent Application Publication
(10) Pub. No.: US 2026/0326052 A1
(43) Pub. Date: Oct. 22, 2026

(54) APPARATUS FOR PASSIVE MIXING OF MULTIPHASE FLOW

(71) Applicant: SRAVATHI ADVANCE PROCESS TECHNOLOGIES PRIVATE LIMITED, Bengaluru (IN)

(72) Inventors: Sreeramagiri Venkata Shanmukha SOURI, Bangalore (IN); Chungikar Abbas SOHEL, Bangalore (IN); Sreeramagiri SIVAKUMAR, Bangalore (IN); Anapat SAMIR, Bangalore (IN)

(21) Appl. No.: 19/115,792

(22) PCT Filed: Sep. 25, 2023
(86) PCT No.: PCT/IB2023/059444

§ 371 Date: Mar. 27, 2025

(30) Foreign Application Priority Data
Oct. 1, 2022 (IN) 202241056441

(51) Int. Cl. B01F 25/432; B01D 11/04; B01F 23/232; B01F 23/45; B01F 33/81

(52) U.S. Cl. CPC B01F 25/43231; B01D 11/0453; B01F 23/232; B01F 23/45; B01F 33/811; B01F 2215/0422

(57) ABSTRACT

The invention discloses an apparatus for passive mixing of a multi-phase flow or hydrodynamic performance that is housing a conduit/tube, which is a channel extending internally from the fluid inlet to the outlet ports, comprising stacked plurality of static mixers possessing structural elements or mixing elements, that are responsible for splitting, twisting and combining of the flow through the conduit, bringing about enhanced mixing of the contents of the flow. The twisting effect offered by the structural elements brings about an enhanced mixing of the multi-phasic systems passing through the conduit such as liquid-liquid, liquid-gas [symbol] liquid, and also systems comprising immiscible and viscous liquids. The conduit comprises of a plurality of axially stacked static mixers across the length of the conduit that can allow the fluid to pass through them continuously experiencing splitting and twisting effects resulting in improved mixing, mass-transfer, and heat transfer.

### RELATED DOCUMENTS

This invention claims priority to the Indian provisional specification titled “APPARATUS FOR PASSIVE MIXING OF MULTIPHASE FLOW” filed on Jan. 10, 2022, with the application No. 202241056441 (TEMP/E1/64442/2022-CHE), and it is incorporated hereby in its entirety for reference.

### FIELD OF THE INVENTION

The invention relates to apparatus comprising static mixers for passive mixing of multiphase flow and more particularly to the intensification of the mixing of multiphasic fluid systems such as liquid-liquid, liquid-liquid-gas systems, and also immiscible fluids by way of cumulative twisting of the flow, in the conduit, due to the presence of static-mixers possessing structural elements.

### BACKGROUND OF THE INVENTION

Static mixers or passive mixers find application in a wide range of process operations, including dosing, dispersion, laminar flow heat-transfer, mass-transfer, and reaction engineering. They are tried, and trusted devices for combining liquids, gases, and powders in many industries. As the name goes by the static mixers are devoid of moving elements and the mixing action is achieved by the continuous splitting, combining, squeezing, twisting of the fluid. Mixing action is accomplished by the inclusion of structural elements such as vanes, plates, helical structures, arcs or by suitably modifying the geometry of the static mixers that can be inserted into a conduit present in a housing suitably, so as to increase the overall mixing of the multiphasic fluid under consideration. Twisting and splitting the flow by way of inclusion of a helical structural element is an interesting way of obtaining intensified mixing using static mixers. Literature search revealed many relevant prior art references pertaining to the intensification of mixing efficiency of multiphasic systems passively using static-mixers possessing structural elements.

Volker Hessel et al reviewed microstructured mixer devices and their mixing principles concerning miscible liquids (and gases) and discussed various passive mixing devices and techniques such as Y- and T-type flow-, multi-laminating-, split-and-recombine-, chaotic-, jet colliding-, recirculation flow-mixers and others (Chemical Engineering Science 60 (2005) 2479-2501).

Patent DE102017217683A1 disclosed a process for the preparation of homogeneous mixtures of particulate components and apparatus for carrying out the same.

Andrew N. Cookson, et al found that helical geometries such as stents and shunts used as cardiovascular prosthetics could induce mixing effectiveness, by embodying a ‘streamline crossing’ flow swirling flow, promoting in-plane mixing (Fluids 2019, 4 (2), 59).

Patent DE102018104840A1 disclosed a mixer having a noncircular flow cross-section fluid conduit to which the successive packages of fluids to be mixed are deliverable.

Sheu, T. S et al described a novel parallel laminar micromixer with two-dimensional staggered curved channels with tapered structures. The split structures of the tapered channels resulted in the uneven split of the mainstream and the reduction of the diffusion distance of two fluids. with tapered structures. They found that the uneven split of two fluids inside the staggered channels improved the mixing performance (Mixing of a split and recombine micromixer with tapered curved microchannels. Chemical Engineering Science, 71, 321-332 (2012).

Patent KR101999164B1 disclosed a nano bubble water generating tube wherein a rotating body is formed by a hexagonal cylinder accommodating therein and which is vertically movable along an upper portion of the upper portion by screwing with an upper and an upper spiral portion formed with a spiral portion on the outside and a driving shaft of a micromotor provided on the upper surface of the rotating body.

Patent WO2009137457 disclosed a multi-phase fluid flow splitting device that includes a feed pipe in which a flow redistribution element induces tangential motion in the phases such that the denser phase is forced to redistribute around the periphery of the feed pipe. The splitting is accomplished by two helical vanes that ran parallel to the longitudinal axis.

Patent U.S. Pat. No. 5,425,581A disclosed a static mixer for mixing of different media comprising mixing elements arranged within a tube, at which the mixing elements are twisted to divide and divert the media wherein each mixing element (1) is twisted 80°-100° and that every second mixing element (1) is twisted counter clockwise while every other element is twisted clockwise.

Patent U.S. Pat. No. 4,314,974A disclosed a solvent extraction method using static mixers wherein the liquids are initially mixed by flowing said aqueous solution and said extraction liquid through a conduit containing a plurality of curved, sheet-like elements extending longitudinally in said conduit and each having a curvature to turn the direction phases flowing through said conduit, said elements being arranged in alternating right-handed and left-handed groups, the leading and trailing edges of adjacent elements being disposed at a substantial angle with respect to each other.

Still there is definitely a scope and necessity to come out with an apparatus for passive mixing especially for the intensification of passive mixing of a multiphase flow using such an apparatus. Hence this instant invention of “Apparatus for passive mixing of multiphase flow” has been taken up. The exemplary aspects of the invention are given in the summary of the invention and are described in detail drawing reference to corresponding figures and tables and experimental results in the detailed description section. The various aspects of the instant invention of “Apparatus for passive mixing of multiphase flow” are definitely an improvement over the existing prior art and definitely find application in processes dealing with liquid-liquid, liquid-liquid-gas, immiscible fluid systems for the intensification of passive mixing and thereby improving product yields, purity. The summary of the various embodiments of the instant invention are given in the following paragraphs hereunder.

### BRIEF DESCRIPTION OF THE FIGURES

Various aspects of the embodiments are illustrated in brief in the following paragraphs with reference to the accompanying figures, which are not necessarily drawn to scale. The figures are included to provide an illustration and a further understanding of the various aspects and embodiments, and are incorporated in, and constitute a part of this specification, but are not intended as a definition of the limits of any particular embodiment. The figures, together with the remainder of the specification, serve only to explain principles and operations of the described and claimed aspects and embodiments, but are not to be construed as limiting embodiments. In the figures, each identical or nearly identical component that is illustrated in various figures is represented by a like numeral. For purposes of clarity, not every component may be labelled in every figure.

FIG. 1 depicts the 3D image of the apparatus with twisting means for intensifying the multi-phasic flow passively.

FIG. 2 shows giving the cross-sectional view of the 3D image of the apparatus with twisting means wherein the assembly of individual ellipsoidal-split-twist static mixers and their arrangement in a conduit is represented, wherein the ellipsoidal splitting and twisting action is realized by way of the structural elements incorporated on the inner walls of the static mixers that have been placed axially in the conduit with gaps in between the individual static mixers at specified intervals showing the split, twisted combined flow areas. The 3D image of the ellipsoidal-split and twist pattern for static mixing of multiphasic fluids is depicted herein. An ellipsoidal-split-twist and combining effect is felt by the multiphasic flow continuously through the entire length of the process side resulting in intensified mixing of the elements of the flow.

FIG. 3 shows the cross-sectional view of the 3D image of the apparatus with cross-twisting means wherein the assembly of the individual cross-twist static mixers and their arrangement in a conduit wherein the cross-twisting action is realized by way of the helical structural elements on the inner walls of the static-mixers that have been placed axially in the conduit, with gaps in between the individual static mixers at specified intervals showing the cross-split-twisted and combined flow areas. 3D image of the cross-twist pattern for static mixing of fluids is depicted herein. A cross-split-twist and combining effect is felt by the multiphasic flow through the entire length of the process side resulting in intensified mixing of the elements of the flow.

FIG. 4 gives the Top view of the embodiment of the invention as depicted in FIG. 2 pertaining to ellipsoidal-split-twist static-mixer.

FIG. 5 gives the Front view of the embodiment of the invention as depicted in FIG. 2 pertaining to ellipsoidal-split-twist static-mixer.

FIG. 6 gives the Side view of the embodiment of the invention as depicted in FIG. 2 pertaining to ellipsoidal-split-twist static-mixer.

FIG. 7 gives the 3D projected view of the embodiment of the invention as depicted in FIG. 2 pertaining to ellipsoidal-split-twist static-mixer.

FIG. 8 gives the Isometric view of the embodiment of the invention as depicted in FIG. 2 pertaining to ellipsoidal-split-twist static-mixer.

FIG. 9 gives the Front view of the embodiment of the invention as depicted in FIG. 3 pertaining to Cross-twist static-mixer.

FIG. 10 gives the Side view of the embodiment of the invention as depicted in FIG. 3 pertaining to Cross-twist static-mixer.

FIG. 11 gives the 3D projected views of the embodiment of the invention as depicted in FIG. 3 pertaining to Cross-twist static-mixer.

FIG. 12 gives the Bottom views of the embodiment of the invention as depicted in FIG. 3 pertaining to Cross-twist static-mixer.

FIG. 13 gives the Special embodiment of the invention as depicted in FIG. 3 pertaining to Cross-twist static-mixer with right-handed twist for one-half pitch, followed by space for expansion of the fluid.

### OBJECTIVES OF THE INVENTION

1. To come out with an apparatus for the intensification of passive mixing of a multiphasic flow by way of splitting and twisting of the multiphasic flow by the structural elements or mixing elements possessed by the static mixers forming an integral part of the apparatus.
2. To come out with an apparatus for the intensification of passive mixing of a multiphasic flow by way of incorporating structural elements or mixing elements on the inner walls of the static mixers which are responsible for splitting, twisting, and combining the different phases of the multiphase flow in such a way that the multiphasic flow experiences alternate twisting and combining in a conduit all along from the inlet port to the outlet port in a housing resulting in a thorough mixing of the flow.
3. To come out with an apparatus for the intensification of passive mixing for multi-phasic systems to achieve higher yields, maximum purity of the final product by way of incorporating structural elements or mixing elements on the inner walls of the individual static mixers that can be stacked in a conduit or tube.

### Summary of the Invention

The exemplary embodiment of the invention discloses an apparatus for passive mixing of a multi-phase flow or hydrodynamic performance that is housing a conduit/tube, which is a channel extending internally from the fluid inlet to the outlet ports, comprising stacked plurality of static mixers possessing structural elements or mixing elements, that are responsible for splitting, twisting and combining of the flow through the conduit, bringing about enhanced mixing of the contents of the flow. The twisting effect due to the structural elements results in enhanced mixing of the multi-phasic flow. The conduit comprises of a plurality of axially stacked static mixers across the length of the conduit that can allow the fluid to pass through them continuously experiencing splitting and twisting and combining effects resulting in improved mixing, mass-transfer, and heat transfer.

An important embodiment of the invention discloses an ellipsoidal-split-twist static mixer for mixing multiphase flow comprising of an elliptical/circular cross-sectional flow area wherein the circular pipe cross-section is first squeezed into a smaller elliptical cross-section, which then splits into two identical radially symmetrical elliptical sub-sections.

Another embodiment of the ellipsoidal-split-twist static mixer discloses an important aspect wherein the central portion of the mixer involves a helical pathway traced by two elliptical sub-sections, the remainder of the length of the static mixer is used to bring the flow back to its original configuration by combining the two sub-sections and then expanding back to the pipe cross-section.

One important embodiment of the invention discloses a Cross-twist static mixer comprising of an asymmetric cross shaped cross sectional flow area that is eccentric to the pipe's central axis.

Yet another embodiment of Cross-twist static mixer discloses a circular pipe cross-section which is first smoothly squeezed into a smaller “x” or asymmetric cross shaped cross-section.

Another embodiment of the cross-twist static mixer discloses a central portion of the mixer involving a helical pathway traced by the cross section wherein the remainder of the length of the static mixer is used to bring the flow back to its original configuration by expanding back to the pipe cross-section.

Yet another embodiment of the invention discloses stacking of the individual static mixers for the achievement of better mixing of individual elements of a multiphase flow.

One important embodiment of the invention discloses construction of the apparatus for passive mixing of multiphase flow that comprised stacked plurality of static mixers possessing structural elements responsible for elliptical-split-twisting and/or cross-twisting of the multiphasic flow in a conduit in a housing and testing and comparing their individual efficiencies in enhancing the mixing efficiency in terms of mass transfer coefficients with respect to a tube reactor without the static-mixers and also batch reactors.

The exemplary aspects of various embodiments of the invention are disclosed in the summary of the invention and all the essential aspects relating the various embodiments of the invention are described in a detailed manner in the following paragraphs with specific references towards the corresponding figures and tables as given hereunder.

All the prior art references are incorporated hereby in their entirety and for reference-sake and in no way taking away the novelty of the instant invention. The various aspects of the invention disclosed herein are definitely an improvement over the existing prior art and further stress upon the inventorship, novelty and applicability of the instant invention in the field of intensification of passive mixing ability of static mixers that operate in split and twisting mode.

### Detailed Description of the Invention

The examples of the apparatus discussed herein are not limited in application to the details of construction and the arrangement of components set forth in the following description or illustrated in the accompanying drawings. It will be understood by one of skill in the art that the apparatus is capable of implementation in other embodiments and of being practiced or carried out in various ways. Examples of specific embodiments are provided herein for illustrative purposes only and are not intended to be limiting. Also, the phraseology and terminology used herein is for the purpose of description and should not be regarded as limiting.

Any reference to examples, embodiments, components, elements or acts of the apparatus herein referred to in the singular may also embrace embodiments Including a plurality, and any reference in plural to any embodiment, component, element, or act herein may also embrace embodiments including only a singularity (or unitary structure). References in the singular or plural form are not intended to limit the presently disclosed apparatus, its components, acts, or elements.

The use herein of “Including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. The various embodiments of invention are described in detail herein and the various aspects of the invention are disclosed below.

### Description of the Embodiment of the Invention Pertaining to Ellipsoidal-Split—Twist Static-Mixer

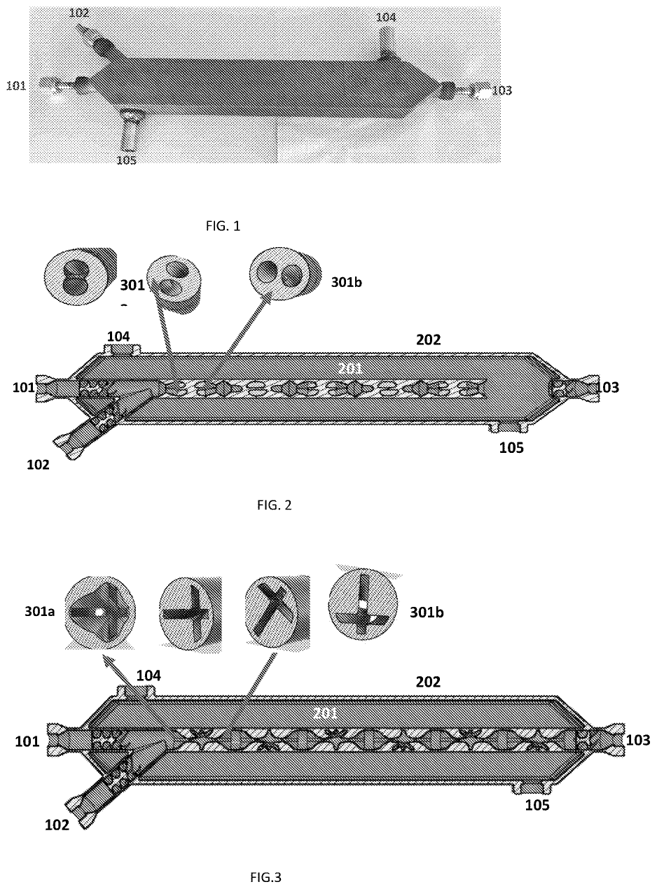

Drawing reference to FIG. 1, which clearly depicts the overall 3D image of the apparatus that is being used for intensifying the mixing in a multi-phasic flow that houses a conduit comprising stacked plurality of static mixers with structural elements that are responsible for splitting, twisting and combining of the flow through the conduit, bringing about the cumulating twisting and combining effect on the flow. The twisting effect results in the enhanced mixing of the multi-phasic flow. FIG. 1 gives the overall picture of the apparatus housing a conduit/tube, the channel extending internally from the fluid inlet to the outlet ports comprising stacked plurality of static mixers. Here 101 & 102 indicate the process fluid(s) inlet ports, 103 indicates process fluid outlet port. 104 and 105 indicate utility fluid inlet and outlet ports respectively. The conduit comprises of a plurality of stacked static mixers across the length of the conduit that can allow the fluid to pass through them continuously experiencing a splitting, twisting and combining effects ensured by the individual static mixers possessing suitable structural elements or mixing elements on their inner walls as is depicted in FIGS. 2 and 3.

Drawing reference to FIG. 2, the specific embodiment shows the cross-sectional view of the apparatus with the stacked plurality of ellipsoidal-split-twisting static mixers wherein the assembly of individual mixers and their arrangement in a conduit is depicted. Here the twisting action is realized by way of the structural elements showing the split, twist and combined flow areas. The dimensions of the conduit on the process side are: tube ID is 10 mm; length of the tube from inlet to outlet is 250 mm, the inner wall thickness is 0.2 mm; Inlet & outlet nozzle Outer diameter is 8.2 mm; Length of tube where static mixers are provided is 205 mm; Inlet nozzle shape is circular in cross-section. On the utility side, the parameters are: thickness is 2 mm; width is 38 mm; Inlet and outlet nozzle diameter is 10 mm; shape is rectangular; The 3D image of the twisting pattern for static mixing of fluids is clearly depicted herein throughout the length of the process side. Here 201 represents the Metal Wall of the inside tube containing static mixers and the flow volume for process fluid, whereas 202 is the outer casing of the wall. 301 a & b represent the blow-up images of the flow path through the ellipsoidal-split-twist static mixers. The unshaded area indicates the path for fluid flow.

### Description of Individual Ellipsoidal-Split-Twist Static Mixer

A monolith static mixer for mixing multiphase flow comprising of an elliptical cross-sectional flow area. The circular pipe cross-section is first squeezed into a smaller elliptical cross-section, which then splits into two identical radially symmetrical elliptical sub-sections. The central portion of the mixer involves a helical pathway traced by these two elliptical sub-sections. The remainder of the length of the static mixer is used to bring the flow back to its original configuration by combining the two sub-sections and then expanding back to the pipe cross-section.

Multiple ellipsoidal-split-twist Static mixers can be stacked axially to enhance the mixing and dispersion of the multiphase flow elements. Each successive mixer that is stacked can be oriented such that the cross-section split happens along different orientations. The smooth convergence of the pipe cross-section to the oval section is provided to introduce a gradual change in cross-section.

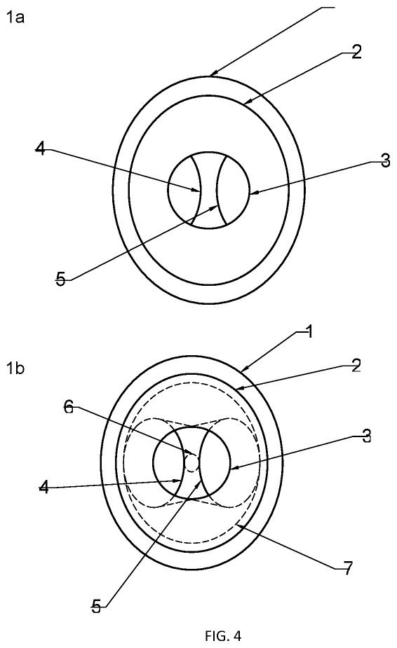

The important embodiment of the instant invention as illustrated drawing reference to FIG. 2, wherein the specific embodiment showing the cross-sectional view of the apparatus with the stacked plurality of ellipsoidal-split-twisting static mixers wherein the assembly of individual mixers and their arrangement in a conduit is further illustrated in the specific embodiments of the invention as depicted in FIGS. 4-8. The specific embodiments of the stacked ellipsoidal-split-twisting static-mixers can be better understood by the different views of the embodiment as illustrated drawing reference to FIGS. 4-8 as given in the following paragraphs taking the guidance parameters as given hereunder.

These guidance parameters are common for all further figures and represent the stated aspects of invention as applicable for each one of the ellipsoidal-split-twisting static mixer unit forming a part of the stack of ellipsoidal-split-twisting static mixers contained in a conduit/pipe or channel contained in a housing. (Reference convention: feature labelled as 3 in FIG. 1a is to be referenced as 1a_3) wherein,
Label Entity 1 represents Outer Diameter of the surrounding pipe of the static mixer; is cylindrical in nature;
Label entity 2 represents Inner Diameter of the surrounding pipe; is cylindrical in nature;
Label entity 3 represents Innermost circumference of the initial squeeze of the static mixer;
Label entity 4 represents First elliptical subsection/cross sectional split;
Label entity 5 represents Second elliptical subsection/cross sectional split;
Label entity 6 represents Junction between split subsections Helical path (twist) traced by the subsections.

One aspect of the invention as depicted in FIG. 2 is further illustrated drawing reference to FIG. 4: Here 1a gives the top view of the ellipsoidal-split-twist static mixer (as approached by the fluid, with flow direction into the paper). It shows only the visible edges. (1a_3,1a_4,1a_5). 1b gives the Top view of the static mixer (as approached by the fluid, with flow direction into the paper). It shows the non-visible edges as dashed lines, which are labelled in addition to the previous FIG. 1b_6,1b_7).

One aspect of the invention as contained FIG. 2 is further illustrated drawing reference to FIG. 5 which gives The Front view of the ellipsoidal-split-twist static mixer. Hidden edges (cross-section split and twist) are depicted as dashed lines. Flow direction is also shown along the length of the tube. Individual static mixer elements are stacked in succession to give enhanced mixing effects. This view shows the splitting of the surface and twisting effect in the lateral direction (FIG. 5_4, 5_5,5_7,5_7′). Identical traces of the helical pathway have been labelled for ease of understanding (5_7,5_7′).

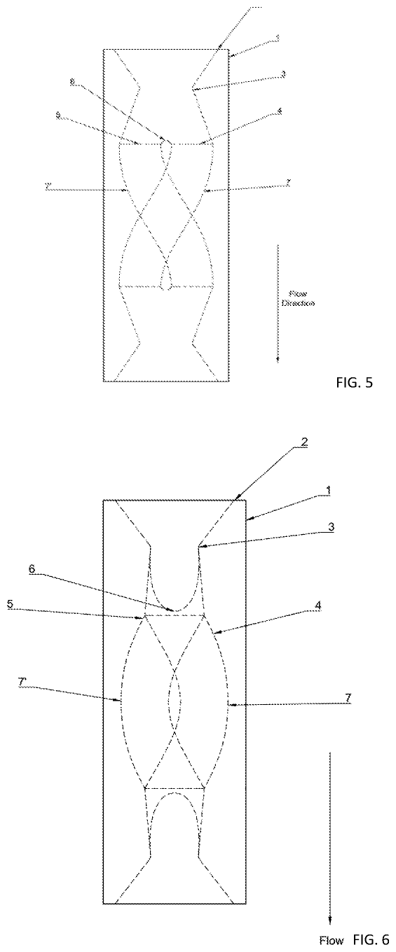

One aspect of the invention as depicted in FIG. 2 is further illustrated drawing reference to FIG. 6 that gives The Side view of the ellipsoidal-split-twist static mixer. Hidden edges (cross-section changes) are depicted as dashed lines. Flow direction is also shown along the length of the tube. Individual static mixer elements are stacked in succession to give enhanced mixing effects. This view shows the split of surface and twisting effect in the frontal-rear direction (FIG. 6_4,6_5, 6_7,6_7′). Identical traces of the helical pathway have been labelled for ease of understanding (6_7,6_7′).

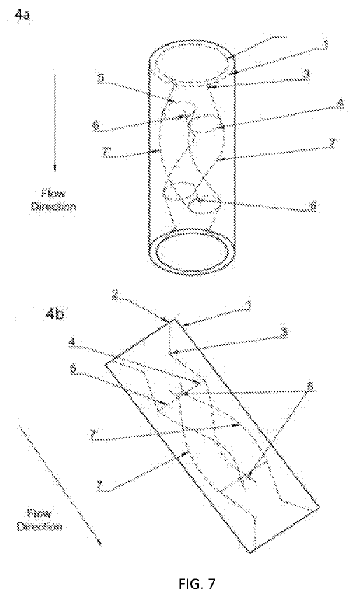

One aspect of the invention as depicted in FIG. 2 is further illustrated drawing reference to FIG. 7: Here 4a gives the bottom 3D projected view of the ellipsoidal-split-twist static mixer, with hidden edges depicted as dashed lines. Flow direction is also shown and is along the length of the tube. Individual static mixer elements are stacked in succession to give enhanced mixing effects. This view is better to understand the structure of the static mixer surface and the nature of its changes. From this view, primarily the three-dimensional nature of split and twisting of subsections are in focus (4a_4, 4a_5, 4a_7, 4a_7′) along with the converging ramp from pipe section to initial squeeze (4a_3). Here 4b gives view of 4a projected onto the side plane. Flow direction is also shown along the length of the tube. This view is to better visualize the region of splitting of cross section and the smooth transition surface (4b_6).

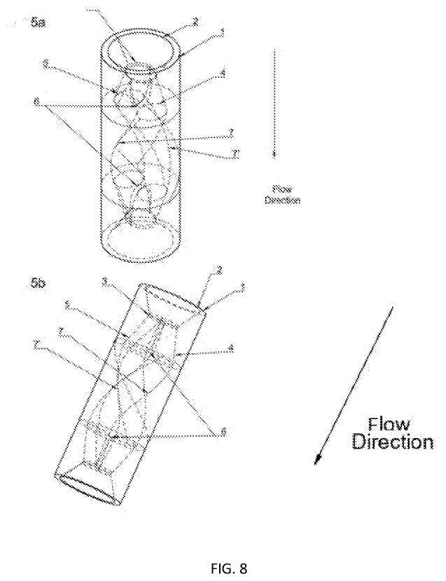

One aspect of the invention as depicted in FIG. 2 is further illustrated drawing reference to FIG. 8: Here 5a gives the right isometric view of the ellipsoidal-twist static mixer, with hidden edges depicted as dashed lines. Flow direction is also shown and is along the length of the tube. From this view, an improved 3D visualization of the cross sections split, and helical pathway are in focus (5a_4,5a_5) along with the converging ramp (5a_3). Here 5b gives the left bottom trimetric view of the static mixer, with hidden edges depicted as dashed lines. Flow direction is also shown and is along the length of the tube. From this view, an improved 3D visualization of the helical pathway (5b_7, 5b_7′) along with the converging ramp (5b_3).

Additional embodiments of the invention as depicted in FIG. 2 and further illustrated drawing reference to FIGS. 4-8, can be realized by varying the key aspects of the invention as given here (a) The entry length and the exit length of the mixer can be varied according to the intended working fluid; (b) The aspect ratio of the initial cross-section to the subsections can be varied, as defined by the relation: Area of subsection/Area of initial cross-section; (c) The cross section can split into “n” number of channels, where n≥2; (d) The cross-sectional split can be asymmetric; (e) The cross-section of the initial squeeze and the subsections of the area split can be of different shapes; (f) The mixer elements can be placed eccentric to the axis of the pipe, or the initial squeeze can be eccentric; (g) The cross-section can be made using an n-sided polygon, where n>3; (h) The twist in the helical path can be an angle ϑ, where 45°≤ϑ≤315°; and (i) The pitch of the helix can be modulated.

The different aspects of the invention pertaining to ellipsoidal split and twist-static mixer are better understood by the changes happening in the flow regime through the channel which can stress upon the incorporation of structural elements responsible for such split-twist mechanism. The following paragraph throws light on this aspect of the invention.

### Description of Flow Through the Individual Ellipsoidal-Split-Twist Static Mixer

The flow regime initially gets squeezed in the radial direction into an elliptical cross-section when it enters the static mixer element. The flow is then squeezed further and split into two identical smaller elliptical cross sections that are radially symmetrical. From here, both the subsections form two separate channels of flow that trace a helical path that induces an angular momentum in the fluid streams. The sub-sections eventually reconverge into a single elliptical cross section and are allowed to expand back to the initial pipe cross-section.

One more important embodiment of the invention as depicted in FIG. 3 pertaining to split-cross-twist static-mixer is described in detail in the following paragraphs.

### Description of the Embodiment of the Invention Pertaining to Split-Cross-Twiststatic Mixer

Drawing reference to FIG. 3, it shows split-cross twist static mixer giving the cross-sectional view of the apparatus which shows an assembly of stacked individual split-cross-twist static mixers and their arrangement in a conduit, wherein the splitting and twisting action is realized by way of the structural elements or mixing elements incorporated on the inner walls of the mixer that are responsible for alternating split and twist zones and combining zones. The 3D image of the apparatus comprising stacked split-cross-twist static-mixers for static mixing of multiphasic fluids is depicted in FIG. 3 which clearly shows splitting, twisting followed by combining zones that are repeated through the length of the process side. Here 201 represents the Metal Wall of the inside tube containing static mixers and flow volume for process fluid, whereas 202 is the wall outer casing. 301 a & b represent the blow-up image of the flow path through the split-cross twist static mixer. The unshaded area indicates the path for fluid flow. The dimensions of the conduit of the of the apparatus comprising stacked static mixers on the process side are: tube ID is 10 mm; length of the tube from inlet to outlet is 250 mm, the inner wall thickness is 0.2 mm; Inlet & outlet nozzle Outer diameter is 8.2 mm; Length of tube where static mixers are provided is 205 mm; Inlet nozzle shape is circular in cross-section. On the utility side the parameters are thickness is 2 mm; width is 38 mm; Inlet and outlet nozzle diameter is 10 mm; shape is rectangular; Here 201 represents the Metal Wall of the inside tube containing static mixers and the flow volume for process fluid, whereas 202 is the outer casing of the wall.

### Description of the Individual Split-Cross-Twist Static Mixer

A monolith static mixer for mixing of a multiphase flow comprising of an asymmetric cross shaped cross sectional flow area. This cross is eccentric to the pipe central axis. The circular pipe cross-section is first smoothly squeezed into a smaller x or asymmetric cross shaped cross-section. The central portion of the mixer involves a helical pathway traced by this cross section. The remainder of the length of the static mixer is used to bring the flow back to its original configuration by expanding back to the pipe cross-section.

Multiple Static mixers can be stacked axially to enhance the mixing and dispersion of the multiphase flow elements. Each successive mixer that is stacked can be oriented such that the helix is of opposite twist, to enhance the mixing. The convergence of the pipe cross-section to the asymmetric cross shape is made of smooth ramps to aid the feasibility of additive manufacturing methods and introduce a gradual change in cross-section.

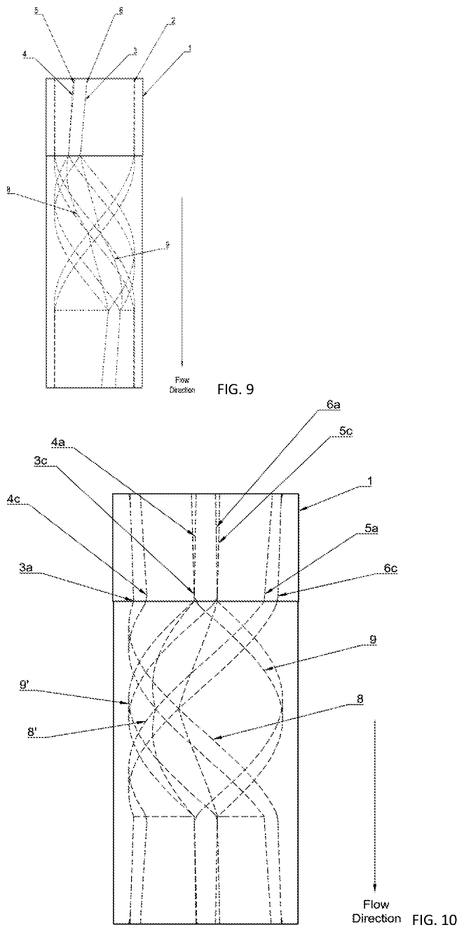

The important aspects of the embodiment of the invention pertaining to the apparatus comprising stacked split-cross-twist-static mixers as depicted in FIG. 3 can be further described drawing reference to FIGS. 9-13 taking the guidance parameters as given in the following paragraph wherein,
Label Entity 1 gives the Outer Diameter of the surrounding pipe of the static mixer; is cylindrical in nature;
Label entity 2 gives the Inner Diameter of the surrounding pipe; is cylindrical in nature;
Label entity 3 gives the Upper left ridge (larger ridge) wherein a. is Flat edge of upper left ridge, b. is Smooth vertex of upper left ridge, c. is Curved edge (largest) of upper left ridge
Label entity 4 gives Upper right ridge (shorter ridge) wherein a. is Flat edge (shortest) of upper right ridge, b. is Smooth vertex of upper right ridge, c. is Curved edge of upper right ridge.
Label entity 5 gives Lower right ridge (shorter ridge) wherein, a. is Flat edge of lower right ridge, b. is Smooth vertex of lower right ridge, c. is Curved edge (shortest) of lower right ridge.
Label entity 6 gives Lower left ridge (larger ridge) wherein, a. is Flat edge (longest) of lower left ridge, b. is Smooth vertex of lower left ridge, c. is Curved edge of lower left ridge.
Label entity 7 gives Central cavity (straight channel) of flow through static mixer.
Label entity 8 gives Helical path traced by vertexes of the shorter ridges (right).
Label entity 9 gives Helical path traced by vertexes of the larger ridges (left).
Label entity 10 gives the Converging ramp from circular cross-section to larger ridges (left).
Label entity 11 gives the Converging ramp from circular cross-section to shorter ridges (right).

one important aspect of the invention as depicted in FIG. 3 is further illustrated drawing reference to FIG. 9 which gives The Front view of the split-cross-twist static mixers. Hidden edges (cross-section change and twist) are depicted as dashed lines. Flow direction is shown along the length of the tube. Individual static mixer elements are stacked in succession to give enhanced mixing effects. This view shows the squeezing of cross section of the surface and twisting effect in the lateral direction (9_8, 9_9).

Another aspect of the invention as depicted in FIG. 3 is further illustrated drawing reference to FIG. 10 which gives The Side view of the split-cross-twist static mixer. Hidden edges (cross-section change and twist) are depicted as dashed lines. Flow direction is also shown along the length of the tube. Individual cross-twist static mixer elements are stacked in succession to give enhanced mixing effects. This view shows the squeezing of cross section of the surface and twisting effect in the frontal/rear direction (10_8, 10_9). Symmetric traces of the helical pathway have been labelled for ease of understanding (10_8′,10_9′).

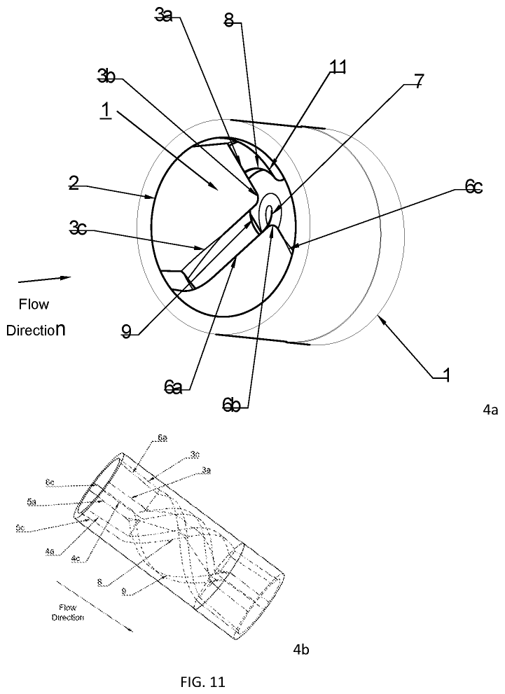

One aspect of invention as depicted in FIG. 3 can be further illustrated drawing reference to FIG. 11 wherein 4a gives Top 3D projected view of the cross-twist static mixer. Flow direction is shown along the length of the tube. This view is to better understand the structure of the static mixer surface and the nature of its changes. From this view, primarily the three-dimensional nature of squeeze and twisting of subsections are in focus (4a_7, 4a_8, 4a_9) along with the converging ramp from pipe section to initial squeeze (4a_10,4a_11). Here 4b gives view of 4a projected onto the side plane, with hidden edges (internal) represented as dotted lines. Flow direction is also shown and is along the length of the tube. This view is to better visualize the 3D nature of the twist region of the cross-section (4b_8,4b_9).

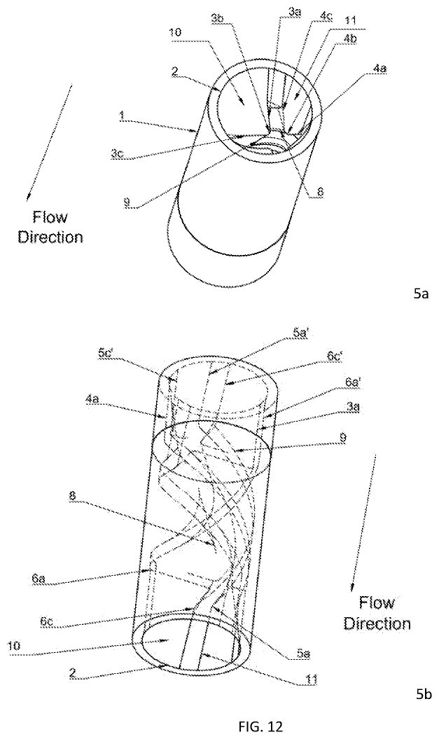

One more aspect of the invention as depicted in FIG. 3 can be further illustrated drawing reference to FIG. 12 wherein 5a gives bottom isometric view of the cross-twist static mixer. Flow direction is also shown and is along the length of the tube. This view is to better understand the structure of the static mixer surface and the nature of its changes. From this view, primarily the three-dimensional nature of squeeze and twisting of subsections are in focus (5a_7, 5a_8,5a_9) along with the converging ramp from pipe section to initial squeeze (5a_10,5a_11) and the curved edge of shorter ridge (5a_4c). Here 5b gives Left bottom trimetric view of the static mixer, with hidden edges depicted as dashed lines. Flow direction is also shown along the length of the tube. From this view, an improved 3D visualization of the helical pathway (5b_8, 5b_9) along with an improved depiction of the static mixer interior surface changes.

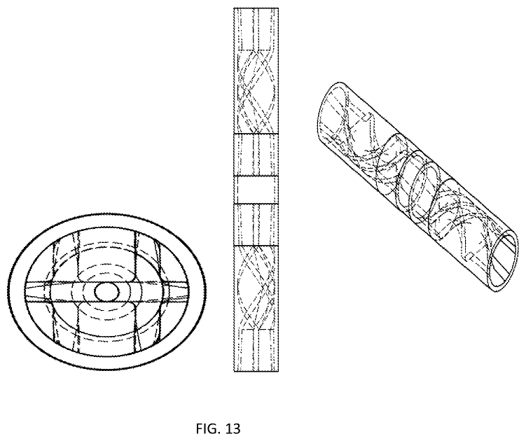

One important aspect of the invention as depicted in FIG. 3 can be further illustrated drawing reference to FIG. 13 which gives an advanced aspect of the embodiment of the crossed twist static-mixer having a right-handed twist for one-half pitch, followed by some space for expansion of the fluid. Following this, the fluid is squeezed into another cross-shaped section, this time with a left-handed twist to disrupt the initial angular momentum and promote further mixing.

Additional embodiments of the invention as depicted in FIG. 3 and further illustrated drawing reference to FIGS. 9-13 to understand the specific embodiments of the same, can be realized by varying the key aspects of the embodiment pertaining to split-cross-twist mixer as given here: The entry length and the exit length of the mixer can be varied according to the intended working fluid; The aspect ratio of the initial cross-section to the subsections can be varied, as defined by the relation: Area of the squeezed cross shape/Area of initial cross-section; The cross-section shape can have n number of limbs where n≥2; The cross-section shape can be eccentric or non-eccentric with the central axis; The cross limbs can have an angle α, where 120/n°≤α≤360*(2/n−1/3n), and n is number of limbs; The twist in the helical path can be an angle ϑ, where 45°≤ϑ≤315°; The pitch of the helix can be modulated. The different aspects of the embodiment containing split-cross-twist static mixers as depicted in FIG. 3 can be better understood in the light of the changes that happen in the flow regime of the multiphasic fluid while passing through the conduit comprising stacked plurality of the split-cross-twist static-mixers possessing structural elements as given in the following paragraph that describes the flow.

### Description of Flow in the Conduit Comprising Stacked Split-Cross-Twist Static-Mixers

The flow regime initially gets squeezed in the radial direction into an asymmetrical cross shape when it enters the static mixer element. From here, the centre and four limbs of the cross, form four channels of flow and trace a helical path that induces an angular momentum in the fluid streams. By tracing half a pitch length, the fluid at the top of the cross-section is effectively displaced to the bottom and forced to remix with the fluid above. The sub-sections eventually reconverge and are allowed to expand back to the initial pipe cross-section.

Accordingly, the apparatus for passive mixing of multiphase flow comprising of stacked plurality of ellipsoidal-split-twist and/or split-cross-twist static mixers as disclosed herein represents a significant improvement over prior art by providing an apparatus comprising stacked plurality of static mixer possessing structural elements that can split and twist and combine the multiphasic flow. The invention uniquely solves the problems of improper mixing experienced by multiphasic systems by providing a superior mixing action in a multi-phasic flow ensuring enhanced mass-transfer, heat-transfer. The invention provides improved mixing and dispersion of gas-liquid systems with minimal pressure head loss downstream of the injection site.

Those skilled in the art will appreciate that the conception, upon which this disclosure is based, may readily be utilized as a basis for designing other products without departing from the spirit and scope of the invention as defined by the appended claims. Therefore, the claims are not to be limited to the specific examples depicted herein. For example, the features of one example disclosed above can be used with the features of another example.

Furthermore, various modifications and rearrangements of the parts may be made without departing from the spirit and scope of the underlying inventive concept. For example, the geometric configurations disclosed herein may be altered depending upon the application, as may be the material selection for the components. Thus, the details of these components as set forth in the above-described examples, should not limit the scope of the claims.

The various embodiments of the invention of “Apparatus for passive mixing of Multiphase flow” are realized in the following examples.

The apparatus for passive mixing of the multiphasic flow comprising a stacked plurality of static mixers that possessed structural elements or mixing elements which are responsible for splitting, twisting (ellipsoidal and cross) and combining the multiphasic-flow thereby enhancing the mixing efficiency of a multiphasic flow are produced as per the detailed description as disclosed by the Instant invention and are tested to evaluate their mixing efficiency experimentally taking water-acetic acid-toluene system and the results are compared with those obtained from experiments conducted on similar lines in batch mode as well as in a tube reactor. The experimental results are given in the following paragraphs.

Mass transfer studies are conducted using the “Apparatus for passive mixing of a multiphase flow” or Static mixer reactors (SMR) as disclosed by the invention to assess and quantify the mixing capabilities of the apparatus or the reactors. Liquid-liquid extraction (LLE) is the physical method employed to ascertain the effective interphase mass transfer in a given system (reactor or mixed vessel or SMR).

The liquid-liquid extraction of the ternary system of water-acetic acid-toluene, is studied in a batch system to obtain equilibrium concentration. The same extraction is performed using the apparatus contained in the instant invention to establish their mass transfer efficiency. Similar experiments were conducted in an empty tubular reactor (without the static mixers as disclosed by the instant invention) with a T-joint, to establish the base line mass transfer coefficients without the static mixers. Mass transfer coefficients are evaluated for the liquid-liquid-extraction of water-acetic acid-toluene in a flow system using the apparatus comprising the stacked static mixers with modified geometry as disclosed in the invention. The enhanced efficiency of, the stacked plurality of the static mixers present inside the apparatus as contained in the instant invention is evaluated by comparing the experimental results.

### Example 1

### Batch Experiment to Establish the Equilibrium Between Toluene and Water Phase for Acetic Acid (AA) Partition

Equal volumes (50 ml) of 30 w/w % Acetic Acid in water (feed, raffinate) and Toluene (extractant) are taken in a Round bottom flask. The mixture is kept for stirring at 950 rpm. Samples are collected for every fifteen minutes, and the mixture is transferred to separating funnel where the ternary system gets separated into two definite layers namely, top organic layer which is toluene dominant and the bottom aqueous layer that is water dominant. Acetic acid content in both the layers is analysed by titrating known amount of sample against 1N NaOH. 15 ml of methanol and water are used as solvents for titrating the organic and aqueous layers respectively. The amount of NaOH consumed is used to determine Acetic acid % in both the layers by using equation 1

$$wt / wt \% Acetic Acid = \frac{\begin{matrix}{N}_{NaOH} \times Vol of NaOH consumed \times \\ Molecular Weight of Acetic Acid\end{matrix}}{10 \times Weight of sample taken} \qquad eqn . 1$$

Burette reading gives the value for the Vol of NaOH consumed in mL. Samples are collected until repetitive burette readings occur. Content of acetic acid taken as normality is used to calculate Partition coefficient (KD) and Mass transfer coefficient (K_{L}a) which is given by equation 2 and 3 respectively.

$${K}_{D} = \frac{[ {AA}_{org} ]}{[ {AA}_{aq} ]} \qquad eqn . 2$$

Where, [AA_{org}] is the concentration of acetic acid in organic phase and [AA_{aq}] implies concentration of acetic acid in aqueous phase. Using the equilibrium concentration and the initial concentration of the solute AA in both the phases the mass transfer coefficient for an interphase mass transfer is calculated according to the equation 3. This will be used in subsequent sections for SMRs.

$${K}_{L} a = \frac{1}{τ} ln ( \frac{{C}_{in} - {C}^{*}}{{C}_{out} - {C}^{*}} ) {min}^{- 1} \qquad eqn . 3$$

Where Cᵢₙ, Cₒᵤₜ are the concentrations of the solute in inlet, outlet of the reactor at time t and C* is the equilibrium concentration. The data obtained from batch studies is summarised in table1. From table1, it can be observed that between 75 to 150 min, the concentration of AA in organic phase remained constant which indicated the attainment of the equilibrium between the two layers. The average concentration of AA in Organic (toluene) phase is taken as the equilibrium concentration and it is found to be 0.634N. This is used as C* in the equation 3 to calculate mass transfer coefficient for all the subsequent calculations for the apparatus comprising static mixer reactors (SMRs).

TABLE 1
Batch study data
Concentration of AA in toluene layer as function
of time of contact in a batch system

| Time | wt % AA | [AA], Normality |
|---|---|---|
| 0 | 0.000 | 0.000 |
| 15 | 2.227 | 0.371 |
| 30 | 1.565 | 0.391 |
| 45 | 3.056 | 0.509 |
| 60 | 3.571 | 0.595 |
| 75 | 3.881 | 0.646 |
| 90 | 3.750 | 0.625 |
| 105 | 3.870 | 0.644 |
| 120 | 3.853 | 0.642 |
| 135 | 3.781 | 0.630 |
| 150 | 3.709 | 0.618 |

| | |
|---|---|
| Equilibrium | |
| concentration of AA in | 0.634N |
| Toluene organic layer | |

### Example 2

### Studies Conducted with the Apparatus Containing Ellipsoidal Twist and Cross-Twist Static Mixer Reactors (SMRS) in a Housing

### Experimental Setup

Liquid-liquid extraction procedure was carried out in SMRs to determine mass transfer coefficient by physical method. Two pumps, a separating funnel, and the SMR constituted the experimental setup. Calibrated metering pumps were used to pump known and desired flow of both the solvent and the feed solution. They enter the SMR, get mixed due to the static mixers (SMs) in the reactor and exchange takes place between immiscible organic and aqueous phases. The outlet of the SMR is connected to a separating funnel, where both phases collect and separate immediately, thereby stopping further exchange of mass between the phases. Each sample that was taken was immediately separated, and the solute content of both the layers was determined. This experiment was carried out at six different residence times: 0.25, 0.5, 1, 1.5, 2, 2.5 minutes, by varying the flow rates of the two liquids. The ratio of flow rates of both phases was maintained constant at all time intervals.

### Experimental Procedure

The feed solution (30% Acetic Acid in water) and solvent (Toluene) are pumped into the SMRs. Here they flow concurrently getting intimately mixed due the presence of the novel SMs and resulting in the mass transfer of acetic acid between the two phases. The flowrates of the pumps are fixed according to residence time, which is given by equation 4.

$$Flowrate = \frac{Volume of reactor}{Residence time} \frac{mL}{min} \qquad eqn . 4$$

The collected mixture is left for separation into aqueous and organic layers. Both the layers are analysed for Acetic Acid content by taking 5 μm of sample and titrating it against 1N NaOH as discussed above. Equilibrium concentration is found by conducting batch studies. Mass transfer coefficient is calculated at each time of residence (t) using equation 3.

The experimental results and the mass transfer coefficients obtained, for the empty tube, ellipsoidal twist and cross-twist SMRS are given below in tables 2, 3 & 4 respectively.

TABLE 2
Estimation of mass transfer coefficients for empty tube with a T-Joint (baseline “flow” reactor)

| | organic layer | | | | | aqueous layer | | | | | | |
|---|---|---|---|---|---|---|---|---|---|---|---|---|
| | | 1.0N | | | | | 1.0N | | | | | |
| | | NaOH | | | | | NaOH | | | | | Mass |
| | wt of | titre | | wt % | | wt of | titre | | % | | | transfer |
| Residence | sample | value, | Calculated | AA | Concetration | sample | value, | Calculated | AA | Concetration | Partition | coefficient |
| time (min) | (gm) | ml | wt % AA | avg | [AA org] (N) | (gm) | ml | wt % AA | avg | [AA aq] (N) | coefficient | min \hat{ }(−1) |
| 0.25 | 5.03 | 1.5 | 1.84 | 1.79 | 0.30 | 5 | 22.5 | 27.8 | 27.84 | 4.636 | 0.064 | 2.501 |
| | 5.01 | 1.4 | 1.73 | | | 5.02 | 22.6 | 27.8 | | | | |
| 0.5 | 5.05 | 1.7 | 2.08 | 2.03 | 0.34 | 5.03 | 22.3 | 27.4 | 27.57 | 4.590 | 0.074 | 1.501 |
| | 5.01 | 1.6 | 1.98 | | | 5 | 22.4 | 27.7 | | | | |
| 1 | 5.05 | 1.9 | 2.33 | 2.27 | 0.38 | 5.03 | 22 | 27.1 | 27.17 | 4.524 | 0.084 | 0.896 |
| | 5.01 | 1.8 | 2.22 | | | 5.01 | 22.1 | 27.3 | | | | |
| 1.5 | 5.02 | 1.9 | 2.34 | 2.40 | 0.40 | 5 | 21.9 | 27.1 | 27.04 | 4.504 | 0.089 | 0.653 |
| | 5.03 | 2 | 2.46 | | | 5.04 | 22 | 27.0 | | | | |
| 2 | 5.01 | 2.1 | 2.59 | 2.59 | 0.43 | 5.02 | 21.8 | 26.9 | 26.91 | 4.482 | 0.096 | 0.561 |
| | 5.01 | 2.1 | 2.59 | | | 5 | 21.8 | 27.0 | | | | |
| 2.5 | 5.06 | 2.2 | 2.69 | 2.64 | 0.44 | 5.02 | 21.7 | 26.7 | 26.74 | 4.454 | 0.099 | 0.464 |
| | 5.02 | 2.1 | 2.59 | | | 5.04 | 21.8 | 26.8 | | | | |

The first column is the residence time set for the articular run. This is for combined flow rates of the liquids and the tube volume is 40 ml. The next 5 columns show the estimation of the concentration of AA in organic layer estimated by titrating the isolated layer with 1N NaOH. Subsequent 5 columns under the Aqueous layer indicate the same estimation for aqueous layer. The column partition coefficient is derived from the equation 2 and the mass transfer concentration is estimated based on equation 3. Equilibrium concentration of AA in organic layer is 0.64N estimated earlier from the batch extraction experiments.

It is to be noted that for a fixed volume of reactor (here a tube), higher the residence time means lower the flow rates. Lower flow rate means less velocity of the liquids through the reactor. It is established in the science that higher the flow rate, better is the mixing and hence the mass transfer coefficient (m.t.c). The trend of m.t.c with residence time seen in the first and last columns of the above table indicate the same trend. Higher residence time, lower the flow rates, slower the velocity therefore lower the mass transfer coefficient. The trend asymptotically reaches a limit, which can be seen from the above data.

Using the same procedure, mass transfer coefficients for the two SMRs namely ellipsoidal-split-twist static-mixer reactor and split-cross-twist static-mixer reactor are estimated. Tables 3. & 4 summarise the data obtained from ellipsoidal twist and cross-twist and combine SMR designs respectively.

TABLE 3
Experimentally Estimated mass transfer coefficient for
different residence times for ellipsoidal-split- twist SMR
Ellipsoidal -Circular twist

| Residence time (min) | Mass transfer coefficient min\hat{ }(−1) |
|---|---|
| 0.25 | 2.92 |
| 0.5 | 1.66 |
| 1 | 0.95 |
| 1.5 | 0.80 |
| 2 | 0.66 |
| 2.5 | 0.52 |

TABLE 4
Experimentally Estimated mass transfer coefficient
for different residence times for Cross twist SMR
Cross twist

| Residence time (min) | Mass transfer coefficient min\hat{ }(−1) |
|---|---|
| 0.25 | 3.06 |
| 0.5 | 1.83 |
| 1 | 1.09 |
| 1.5 | 0.75 |
| 2 | 0.59 |
| 2.5 | 0.48 |

From tables 2,3 & 4 it can be concluded that continuous systems with SMRs the twist SMR designs show higher mass transfer coefficient compared to empty Tubular reactor due to the presence of static mixers comprising structural elements or mixing elements on their inner walls that are responsible for the splitting and twisting of the different phases of water-acetic acid-toluene system. This establishes the utility of the SM designs disclosed in the invention for effective and enhanced interphase mass transfer devices.

### Advantages of the Invention

The apparatus for enhancing mixing efficiency of multi-phasic passive flow by way of splitting, twisting and combining disclosed herein has the following advantages,
1. A significant improvement over prior art by providing an apparatus comprising a stacked plurality of static mixers comprising structural elements or mixing elements responsible for the intensification of mixing of multiphasic flow by splitting and twisting of the flow in the conduit, by uniquely providing a superior mixing action in a multi-phasic flow.
2. The apparatus disclosed herein ensures enhanced mass-transfer, heat-transfer and improved mixing and dispersion of gas-liquid systems with minimal pressure head loss downstream of the injection site,
3. The apparatus disclosed herein operates by splitting and twisting actions exhibited by the structural or mixing elements possessed by the individual static mixers thereby offering a thorough mixing in multi-phasic systems and can be employed in additive manufacturing, process industries, as is exemplified from the experimental results obtained in the liquid-liquid-extraction studies done with water-acetic acid-toluene system wherein the invention provided better mass-transfer coefficient compared to the same done in a static mixer devoid of such structural or mixing elements.
4. The heat transfer of the fluid to exterior of the mixer is enhanced due to the high turbulence and vortices formed in the flow regime, which increases the mass transfer between the liquid and gaseous phases.

### Analysis of Novelty, Inventiveness and Utility

The instant invention of “APPARATUS FOR PASSIVE MIXING OF MULTI-PHASE FLOW” is novel in the light of the prior art as it provides an apparatus or reactor comprising a stacked plurality of static mixers possessing structural or mixing elements that could split, twist and combine the multiphasic flow in the conduit that considerably enhanced the mixing of a multiphasic-flow as is evident from the mass-transfer coefficients obtained from the liquid-liquid extraction studies done using water-acetic acid-toluene system. The inventiveness of the instant invention lies in arriving at the apparatus comprising stacked plurality of static-mixers possessing structural elements or mixing elements that could enhance the mixing efficiency in multi-phasic flow systems by way of splitting and twisting the multiphasic flow in a conduit, which can be employed successfully in processes to obtain better yields. The various arrangements of the structural elements or mixing elements that could split and twist the multiphasic flow in ellipsoidal and cross modes s as illustrated in the various embodiments of the instant invention are indicative of the inventiveness of the instant invention. The utility aspect of the instant invention is realized as the instant invention discloses an apparatus that can provide enhanced mixing efficiency in multi-phase flows and which can be successfully employed in chemical process industry for specialty chemicals, pharmaceutical intermediates and API production, polymer production wherein a thorough mixing of the different phases has a profound effect on the yield and purity of the final product.

What is claimed:

1. An apparatus for the passive mixing of a multi-phase(ic) flow or hydrodynamic performance comprising a housing, having a conduit/tube or a channel extending internally from the fluid inlet to the outlet ports that comprises of stacked plurality of static-mixers possessing structural elements or mixing elements on the inner walls of the individual static mixers that are responsible for ellipsoidal-split-twist or split-cross twist of the multiphasic flow through the conduit, bringing about the twisting effect on the flow wherein,
a) The twisting is preceded by the splitting of the flow, resulting in an enhanced mixing of the multi-phasic flow,
b) The conduit comprises of a stacked plurality of, static-mixers possessing structural elements, across the length of the conduit that can allow the fluid to pass through them continuously experiencing splitting and twisting and combining, resulting in enhanced mixing, mass-transfer, and heat transfer,
c) The stacking of the individual static-mixers leaves gaps at regular intervals at which places the split and twisted multiphasic flow combines and,
d) The multiphasic flow experiences a cumulative splitting-twisting-combining effect resulting in an enhanced overall mixing efficiency due to plurality of static-mixers that are placed axially along the length of the conduit.

2. The static mixer possessing structural elements responsible for ellipsoidal-split-twist for mixing multiphase flow as claimed in claim 1 comprising of an elliptical/circular cross-sectional flow area wherein the circular pipe cross-section is first squeezed into a smaller elliptical cross-section, which then splits into two identical radially symmetrical elliptical sub-sections.

3. The static mixer possessing structural elements responsible for ellipsoidal-split-twist for mixing multiphase flow as claimed in claim 1 wherein, the central portion of the mixer involves a helical pathway traced by two elliptical sub-sections, the remainder of the length of the static mixer is used to bring the flow back to its original configuration by combining the two sub-sections and then expanding back to the pipe cross-section.

4. The static mixer possessing structural elements responsible for split-Cross-twist as claimed in claim 1 comprising of an asymmetric cross shaped cross sectional flow area that is eccentric to the pipe's central axis.

5. The static mixer possessing structural elements responsible for split-Cross-twist as claimed in claim 1 comprising of a circular pipe cross-section which is first smoothly squeezed into a smaller “x” or asymmetric cross shaped cross-section.

6. The static mixer possessing structural elements responsible for split-cross-twist as claimed in claim 1 comprising of a central portion of the mixer involving a helical pathway traced by the cross section wherein the remainder of the length of the static mixer is used to bring the flow back to its original configuration by expanding back to the pipe cross-section.

7. The enhancement of the mixing efficiency of the passive mixing of a multi-phase(ic) flow by the apparatus comprising of stacked plurality of static-mixers possessing structural elements responsible for ellipsoidal-split-twist as claimed in claim 1 can be further enhanced by varying,
a) The entry length and the exit length of the mixer according to the intended working fluid,
(b) The aspect ratio of the initial cross-section to the subsections as defined by the relation: Area of subsection/Area of initial cross-section,
(c) The splitting of the cross section into “n” number of channels, where n≥2,
(d) The cross-sectional split to asymmetric,
(e) The cross-section of the initial squeeze and the subsections of the area split to be of different shapes,
(f) The placement of mixer elements to be eccentric to the axis of the pipe, or the initial squeeze to be eccentric,
(g) The cross-section using an n-sided polygon, where n≥3,
(h) The twist in the helical path by an angle ϑ, where 45°≤ϑ≤315°,
(i) The pitch of the helix.

8. The enhancement of the mixing efficiency of the passive mixing of a multi-phase(ic) flow by the apparatus comprising of stacked plurality of static-mixers possessing structural elements responsible for split-cross-twist of the flow as claimed in claim 1 can be further enhanced by varying,
a) The entry length and the exit length of the mixer according to the intended working fluid,
b) The aspect ratio of the initial cross-section to the subsections as defined by the relation: Area of the squeezed cross shape/Area of initial cross-section,
c) The cross-section shape to have ‘n’ number of limbs where n≥2,
d) The cross-section shape to eccentric or non-eccentric with respect to the central axis,
e) The angle α of the cross limbs, where 120/n°≤α≤360*(2/n−1/3n), and n is number of limbs,
f) The twist in the helical path by an angle ϑ, where 45°≤ϑ≤315°,
g) The pitch of the helix.

9. The multiphase(ic) flow as claimed claim 1 selected from a group comprising of liquid-liquid, liquid-gas, liquid-liquid-gas, immiscible solvent systems, highly viscous liquids, liquid-solid, ternary systems, solvent-extraction-systems.

10. The apparatus as claimed in claim 1 for enhanced mixing of a multi-phasic flow ensuring enhanced mass-transfer, heat-transfer and improved dispersion in case of gas-liquid systems with minimal pressure head loss downstream of the injection site.
